(19) United States
(12) Patent Application Publication
(10) Pub. No.: US 2017/0228269 A1
(43) Pub. Date: Aug. 10, 2017

(54) PROXIES FOR NATIVE CODE ACCESS

(71) Applicant: HEWLETT-PACKARD DEVELOPMENT COMPANY, L.P., HOUSTON, TX (US)

(72) Inventors: ZI-JIANG YANG, SHANGHAI (CN); XI HE, SHANGHAI (CN); SHENG CAO, SHANGHAI (CN); FAN YANG, SHANGHAI (CN)

(21) Appl. No.: 15/501,236

(22) PCT Filed: Oct. 31, 2014
(86) PCT No.: PCT/CN2014/090066

§ 371 Date: Feb. 2, 2017

(51) Int. Cl. G06F 9/54; G06F 9/445

(52) U.S. Cl. CPC G06F 9/548; G06F 9/44521

(57) ABSTRACT

A device includes a processor coupled to a non-transitory storage device couple which may store machine instructions executable by the processor to implement a first Java Native Interface (JNI) proxy and a JNI bridge. The JNI proxy. Through the use of the JNI proxy, native code may be accessed.

### BACKGROUND

Applications for mobile devices such as smart phones are becoming more and more complex and resource demanding. This is due to the rapid growth of multimedia data processing, gaming, 3D graphics modeling, and context-aware computation on mobile devices. Users want more and more functionality in their applications (“apps”), but such apps run on mobile devices that may have limited performance and limited battery power (before recharging is needed).

### BRIEF DESCRIPTION OF THE DRAWINGS

For a detailed description of various examples, reference will now be made to the accompanying drawings in which:

FIG. 1 shows a system including a mobile device communicatively coupled to a computing device in accordance with various examples;

FIG. 2 illustrates additional detail of the system of FIG. 1 in accordance with various examples;

FIG. 3 shows an implementation of either or both of the mobile device or computing device in accordance with various examples;

FIG. 4 shows an implementation of either or both of the mobile device or computing device in accordance with an additional examples;

FIG. 5 shows a method in accordance with various examples; and

FIG. 6 shows a method in accordance with another example.

### DETAILED DESCRIPTION

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections.

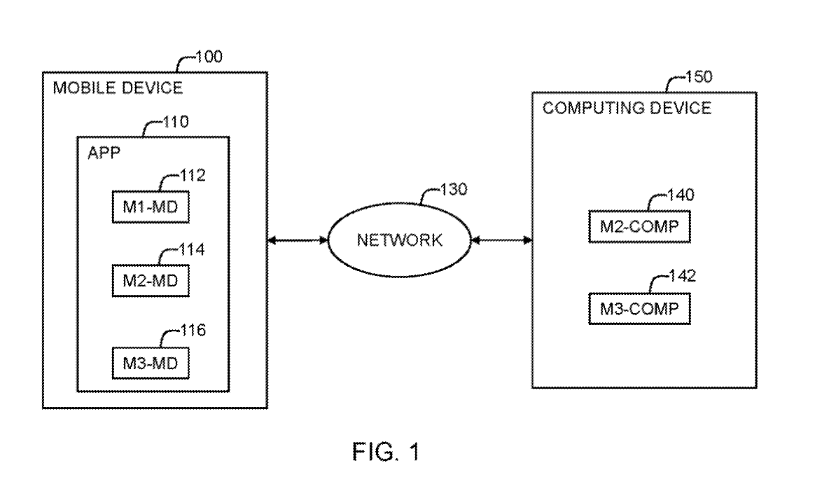

FIG. 1 illustrates a mobile device 100 communicatively coupled to a computing device 150 via a network 130. The mobile device 100 may be a smart phone, tablet, wearable computing device, laptop, convertible laptop, or other type of mobile computing device. The computing device 150 may be a computer such as a server. The network 130 provides connectivity between the mobile device 100 and the computing device 150. The network 130 may represent a combination of wireless local area networks, wireless broadband communications with respect to a base station, wired networks, the Internet, etc. In some examples, the mobile device 100 communicates wirelessly with a wireless local area network which has connectivity over a wide area network to the computing device 150.

The mobile device 100 may store one or more applications (“apps”) 110 for use by a user of the mobile device 100. The apps may perform any of a variety of functions. Apps 110 may be implemented in a variety of programming language. In one implementation an app 110 is implemented in the Java programming language.

Each app 110 may comprise one or more modules. In the example of FIG. 1, app 110 includes three modules M1-M3. Each module performs a portion of the functionality of the app. One or more of the modules may be executed either on the mobile device 100 or on the computing device 150. In the example of FIG. 1, modules M2 and M3 are executable on either the mobile device 100 or on the computing device 150, while module M1 is executable only on the mobile computing device 100. The modules on the mobile device 100 are designated as M1-MD 112, M2-MD 114, and M3-MD 116 to designate those instances of the modules as being executable by the mobile device (“MD”). The instances of modules M2 and M3 stored on the computing device 150 are designed as such by the designators M2-COMP 140 and M3-COMP 142.

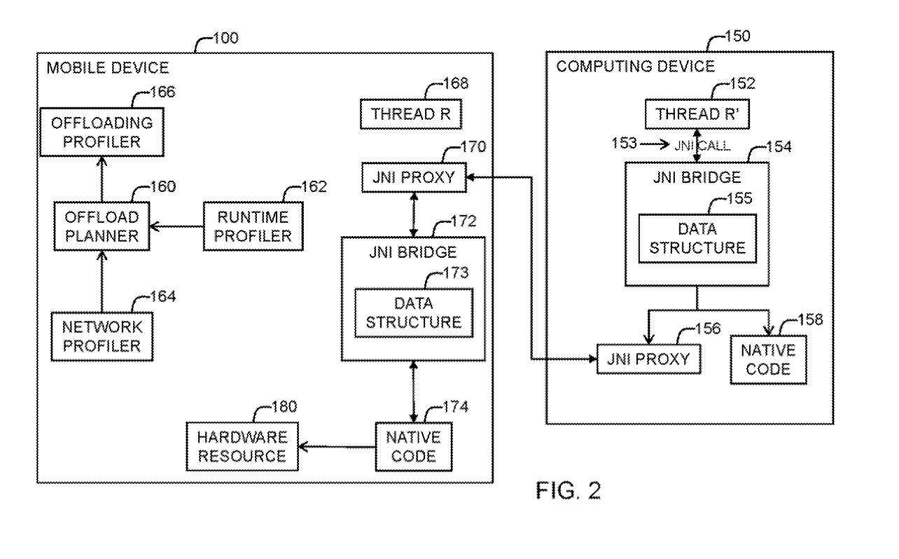

FIG. 2 illustrates an example of mobile device 100 and computing device 150 (network 130 is not shown for simplicity). The example shown in FIG. 2 primarily shows the software components that are usable to implement at least some of the principles disclosed herein. The functions attributed below to each software component are performed by a hardware processor executing the corresponding software component.

For each software module hat executable on either the mobile device 100 or on the computing device 150, the mobile device 100 determines on which device that particular software module should be executed. This determination is made independently for each software module, so that one software module may be executed on the mobile device 100 while another software module may be executed on the computing device 150. In general, all software modules may be determined to be best executed on the mobile device, or all software modules may be determined to execute on the computing device 150. Further still, the determination may result in a mix of software module execution on both the mobile device 100 and the computing device 150.

Determining on which device to have a particular module executed is referred to as “offloading” the module. Any suitable technique for determining how to offload the software modules may be employed. In one example, the offloading decision is made based, on considerations of execution speed and power consumption. For a particular module of an app to be executed on the mobile device, the mobile device will consume power (e.g., battery power) to execute that module, and it will take the mobile device a certain amount of time to execute the module. On the other hand, the computing device could execute the same module and, in that case, the mobile device would not have to consume power to execute the module but would have to expend power to communicate with the computing device 150 (e.g., to send and receive wireless communications on its local wireless LAN or with respect to a base station). Further, the time to execute the module on the computing device 150 would also include the time required to transmit a request and data from the mobile device 100 to the computing device 150 and the time to receive any responses back to the mobile device from the computing device. In accordance with an implementation, the mobile device considers both power expenditure and speed issues to determine whether to offload a given module for execution on the computing device 150.

Equation (1) below compares the speed of executing the module on the mobile device versus the speed of executing the module on the computing device:

$$\frac{{t}_{m} {S}_{m}}{{S}_{s}} + \frac{d}{B} < {t}_{m} \qquad ( 1 )$$

where tₘ is the computation time of the offloading candidate module on the mobile device (i.e., the amount of time it would take for the mobile device to execute the module), sₘ and sₛ are the computation speed of the candidate module on the mobile device and the computing device, respectively, d is the data transfer overhead (e.g., the quantity of data to be transferred between mobile device and computing device), and B is the bandwidth of the communication link between the mobile device and the computing device. The left-hand side of equation (1) above computes the amount of time the module will take to execute if offloaded to the computing device 150 plus the amount of time for data transfer between mobile device 100 and computing device 150. The right-hand side of equation (1) is the computation time of the module on the mobile device 100. The two computation times can be compared to determine on which device (mobile device 100 or computing device 150) the module would execute most expeditiously considering also the time required for data transmissions between the devices if the module were offloaded.

Equation (2) below analyzes the power consumption effects on the mobile device based on whether the mobile device or the computing device execute the module.

$$\frac{{P}_{w} ( B ) d}{B} < {P}_{m} {t}_{m} \qquad ( 2 )$$

where P_{w}(B) represents the power consumption of the mobile device in transmitting and receiving data (e.g., via its wireless local area network or wireless communications with a base station), Pₘ is the power consumption of the mobile device. The power consumption may be a function of bandwidth—higher bandwidth communications generally result in higher power consumption of the mobile device. The left-hand side of equation (2) computes the energy expended by the mobile device 100 in exchanging data d with the computing device 150 if the module were offloaded to the computing device. In that case, the mobile device would only be required to send data to and receive data from the computing device and not expend energy in executing the module itself. The right-hand side of equation (2) computes the energy expended by the computing device in executing the module at a power consumption level of Pₘ for time tₘ.

Referring back to FIG. 2, the mobile device 100 includes an offload planner 160 which receives input from a runtime profiler 162 and a network monitor 164. The runtime profiler 162 may measure the potential data transfer overhead and the computation time of offloading the candidate software modules. The potential transfer overhead is measured by accumulating the size of data passed through the Java Native Interface (JNI) (discussed below) and the size of objects counted in access pattern profiling. The size of the data (d) is provided by the runtime profiler 162. The computation time (tₘ) on the mobile device 100 is also measured by the runtime profiler 162 or may have been determined apriori. The runtime profiler 162 further provides the executing speed (sₘ) of the mobile device 100, while the executing speed (sₛ) of the computing device is known apriori. The network profiler 164 measures the power consumption (P_{w}(B)) of the mobile device 100 during data transmissions to/from the mobile device and also determines the bandwidth of the mobile device's local communication capability (be it WiFi, cellular, etc.).

The data required by equations (1) and (2) above are provided by the runt-time profiler 162 and the network profile 164 to the offload planner 160 which computes equations (1) and (2). In one example, the offload planner 160 makes a determination to offload the module if both the equalities in equations (1) and (2) favor execution on the computing device 150. That is, offloading to the computing device 150 may occur if:

it would be faster to execute the module on the computing device than on the computing device taking the data transfer time into account, and

power consumption on the mobile device would be less if the module were offloaded than if the module were executed on the mobile device

The following discussion assumes that a decision to offload a software module to the computing device 150 has indeed been made. In the example of FIG. 2, the app is implemented in the Java programming language, although as explained above, other programming languages are possible. The app's module is executed in a thread R 168. The arguments of the component to be offloaded (e.g., a Java method invoked by thread R) are sent to the computing device 150 for execution environment setup. In one example, the arguments may include class name, method name, and the parameters passed by the caller of the module. On receiving the arguments, a virtual machine on the computing device 150 may spawn a shadow thread R′ 152 corresponding to thread, create a stack frame for method M with the parameters passed by its caller, and set a program counter for R′ to the first bytecode of method M to start the execution. Upon completion of method M's execution on the computing device 150, a result may be sent back to the caller on the mobile device 100 and the execution resumes within thread R on the mobile device,

While executing thread R′ on the computing device 150 (e.g., while executing a module of an app that has been offloaded to the computing device), the thread R′ may need to access a hardware resource 180 on the mobile device 100. The hardware resource may include, for example, one or more hardware devices of the mobile device 100 such as a speaker, a display, a microphone, and a button. The display may be a non-touch or a touch sensitive display. The button may be a physical button provided on the display and/or may be a soft button implemented on the display itself (in the case in which the display is a touch-sensitive display). As described below, the thread R′ may access the hardware resource 180 using the JNI bridge 154 and JNI proxy 156 on the computing device 150, as well as the JNI proxy 170, JNI bridge 172 and native code 174 on the mobile device 100. The native code 174 on the computing device 100 may be implemented in a language other than the programming language of the app, which itself may be Java. Thus, the native code may not be Java code. The native code 174 may function to access the hardware resource 180 on the mobile device 100.

Referring still to FIG. 2, the thread R′ issues a JNI call 153 for access to a particular native code as identified in the JNI call itself. In one example, the JNI call 153 identifies the native code by a name value. The JNI call 153 is provided to the JNI bridge 154 in the computing device 150. The JNI bridge 154 may determine whether the requested native code is resident on the computing device 150 or on the mobile device 100. In one implementation, the JNI bridge 154 includes a data structure 155 such as a look-up table that lists various native codes and their location (on the computing device 150 or on the mobile device 100). The location may be specified as an address.

The JNI bridge 154 cross-references the JNI native code specified in the JNI call to the particular device—mobile device 100 or computing device 150. If the native code requested in the JNI call is located in the mobile device 100 (as determined by the JNI bridge 154), the JNI bridge 154 provides the JNI call to the JNI proxy 156 on the computing device to forward the JNI call to the JNI proxy 170 on the mobile device 100 to thereby cause the native code 174 on the mobile device to be accessed. The JNI proxies 156 and 170 may be pass-through logic elements which pass through a received JNI call. That is, the JNI proxies 156, 170 may not otherwise process the JNI calls.

The JNI bridge 172 on the mobile device 100 receives the JNI call from the JNI proxy 170. The JNI bridge 172 may have a data structure 173 such as a look-up table as well that cross-references native code specified in the JNI calls to their exact location (e.g., by address) in storage on the mobile device 100.

If the native code 174 generates a response, the response may be provided to the JNI proxy 170 which forwards the response to the JNI proxy 156 on the computing device. Thus, any response messages or data may be received by the JNI proxy on the computing device and provided back to the thread R′.

If, however, the JNI bridge 154 on the computing device 150 determines that that native code specified by the JNI call 153 is resident on the computing device 150 and not on the mobile device 100, the JNI bridge 154 on the computing device does not provide the JNI call to the JNI proxy 156 and, instead causes the native code 158 resident on the computing device 150 to be executed. The native code 158 on the computing device 150 may perform tasks other than accessing a hardware resource 180 on the mobile device 100.

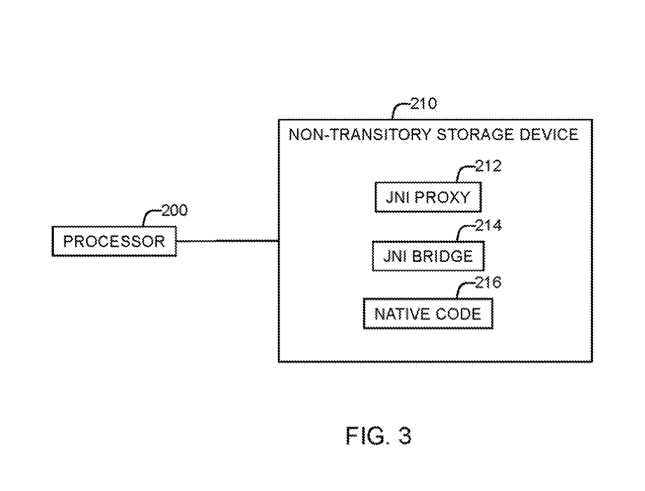

FIG. 3 illustrates an example of a hardware architecture that may be used to implement either or both of the mobile device 100 and the computing device 150. A processor 200 couples to a non-transitory storage device 210. The non-transitory storage device 210 may be non-volatile storage implemented, for example, as solid state memory (e.g., Flash memory), optical storage, magnetic storage, or may be implanted as volatile storage such as random access memory. In an example in which the mobile device 100 is a smart phone and the computing device 150 is a server computer, the non-transitory storage device in the smart phone may be solid state, non-volatile storage while the non-transitory storage device in the computing device 150 may be a hard drive.

The non-transitory storage device 210 may store machine instructions executable by the processor 200 of the respective mobile device 100 and computing device 150. The machine instructions may be executed to implement a JNI proxy 212, a JNI bridge 214 and native code 216. On the mobile device 100, the JNI proxy 212, a JNI bridge 214 and native code 216 correspond, respectively, to the JNI proxy 170, a JNI bridge 172 and native code 174. On the computing device 150, the JNI proxy 212, a JNI bridge 214 and native code 216 correspond, respectively, to the JNI proxy 156, a JNI bridge 154 and native code 158.

Using the example architecture of FIG. 3, the mobile device 100 includes a processor 200 coupled to a non-transitory storage device 210 that stores machine instructions executable by the processor 200 to implement a JNI proxy 170 and a JNI bridge 172. The JNI proxy 170 is to cause the processor 200 to receive a JNI call from a JNI proxy 156 on computing device 150 over a network and forward the received JNI call to the JNI bridge. The JNI bridge 172 contains a data structure to identify locations of native code on the mobile device 174 corresponding to JNI calls. The JNI bridge 172 is to receive a JNI call from the JNI proxy (received from the computing device's JNI proxy 156), to determine the location of native code 174 corresponding to the received JNI proxy, and to cause the native code to be executed by the processor 200.

Using the example architecture of FIG. 3, the computing device 100 includes a processor 200 coupled to a non-transitory storage device 210 that stores machine instructions executable by the processor 200 to implement a JNI proxy 156 and a JNI bridge 154. The non-transitory storage device 210 also stores native code. The JNI bridge 154 receives a JNI call 153 for access to native code. The JNI bridge 154 may determine whether the requested native code is resident on the computing device 150 or resident on the mobile device 100. If the native code associated with the JNI call is resident on the mobile device 100, the JNI bridge 154 provides the JNI call to the JNI proxy 156 on the computing device to forward the JNI call to the JNI proxy 170 on the mobile device 100 to thereby cause the native code 174 on the mobile device to be accessed.

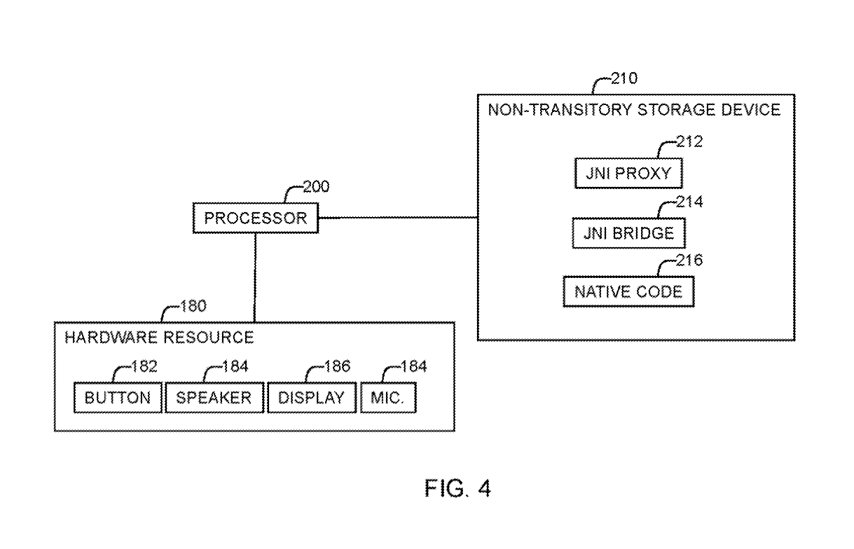

FIG. 4 illustrates an architecture similar to that of FIG. 3 but particularly suited for implementing the mobile device 100. In, the example of FIG. 4, the processor 200 also couples to the hardware resource 180 which may be implemented, as shown, as any one or more of a button 182, a speaker 184, a display 186 and a microphone 188.

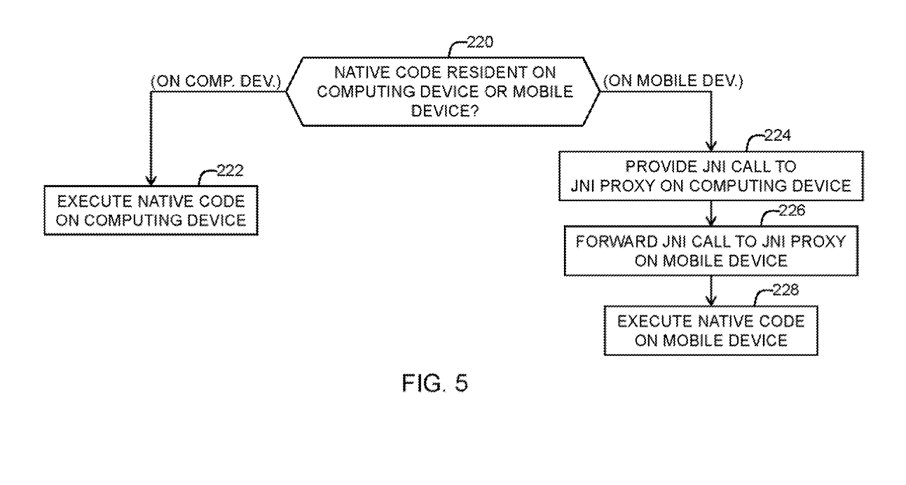

FIG. 5 illustrates an example of a method. The operations depicted may be performed in the order shown, or in a different order. Further, two or more of the operations may be performed in parallel rather than sequentially. The method is executed by the hardware described herein.

At 220, the method includes determining, for example, by the computing device 150 (using, for example, the JNI bridge 154) and based on a JNI call for native code, whether the native code associated with the JNI call is resident on the computing device 150 or on the mobile device 100. At 222, if the native code is resident on the computing device 150, the method includes executing the native code by the computing device. However, if the native code is resident on the mobile device 100, the method includes at 224 providing the JNI call to a JNI proxy 156 on the computing device 150 and at 226 forwarding, by the JNI proxy 156 on the computing device, the JNI call to the JNI proxy 170 on the mobile device. At 230, the native code is then executed on the mobile device 100.

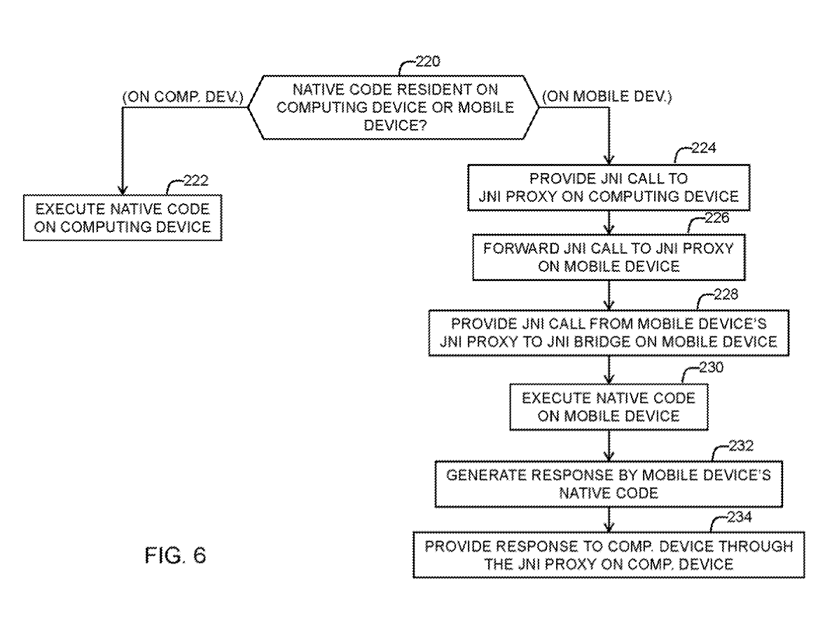

FIG. 6 illustrates another example of a method. The operations depicted may be performed in the order shown, or in a different order. Further, two or more of the operations may be performed in parallel rather than sequentially.

At 220, the method includes determining, for example, by the computing device 150 and based on a JNI call for native code, whether the native code associated with the JNI call is resident on the computing device 150 or on the mobile device 100. At 222, if the native code is resident on the computing device 150, the method includes executing the native code by the computing device. However, if the native code is resident on the mobile device 100, the method includes at 224 providing the JNI call to a JNI proxy 156 on the computing device 150 and at 226 forwarding, by the JNI proxy 156 on the computing device, the JNI call to the JNI proxy 170 on the mobile device. At 228, the method includes providing the JNI call from the JNI proxy 170 of the mobile device 100 to the mobile device's JNI bridge 172. At 230, the native code is executed on the mobile device 100. At 232, the method includes the native code on the mobile device generating a response which is provided (at 234) to the computing device through the JNI proxy 170 on the mobile device 100 to the JNI proxy 156 on the computing device 150.

The above discussion is meant to be illustrative of the principles and various examples of the present subject matter. Numerous variations and modifications will become apparent to those skilled in the art once the above disclosure is fully appreciated. It is intended that the following claims be interpreted to embrace all such variations and modifications.

1. A mobile device, comprising:
a processor;
a non-transitory storage device coupled to the processor and storing; machine instructions executable by the processor to implement a first Java Native Interface (JNI) proxy and a JNI bridge;
wherein the first JNI proxy is to cause the processor to receive a JNI call from a second JNI proxy on a computing device over a network and forward the received JNI call to the JNI bridge;
wherein the JNI bridge contains a data structure to identify locations of native code on the mobile device corresponding to JNI calls; and
wherein the JNI bridge is to receive the JNI call from the JNI proxy, to determine the location of native code corresponding to the received JNI proxy, and to cause the native code to be executed by the processor.

2. The mobile device of claim 1 wherein the first JNI proxy on the non-transitory storage device of the mobile computing device is to receive a result of an execution of the native code and to provide said result over the network to the computing device's second JNI proxy.

3. The mobile device of claim 1 wherein the native code is not Java code.

4. The mobile device of claim 1 wherein the native code is to access a hardware resource on the mobile device.

5. The mobile device of claim 4 wherein the hardware resource is at least one of a speaker, a display, a microphone, and a button.

6. A computing device, comprising:
a processor; and
a non-transitory storage device coupled to the, processor and storing machine instructions executable by the processor to implement a first Java Native Interface (JNI) proxy and a JNI bridge, and also storing first native code;
wherein, when the JNI bridge receives a JNI call for access to native code, the JNI bridge is to determine whether the requested native code is resident on the computing device or resident on a mobile device accessible to the computing device over a network; and
wherein, if the native code associated with the JNI call is resident on the mobile device, the JNI bridge provides the JNI call to the JNI proxy to forward the first JNI call to a second JNI proxy on the mobile device to thereby cause the native code on the mobile device to be accessed.

7. The computing device of claim 6 wherein if the native code associated with the JNI call is resident on the computing device, the first bridge does not provide the JNI call to the first JNI proxy and instead causes the native code resident on the computing device to be executed.

8. The computing device of claim 6, if the native code associated with the JNI call is resident on the mobile device, the first JNI proxy is to receive a result of an execution of the native code over the network from the second JNI proxy.

9. The computing device of claim 6 wherein the JNI call is to use native code to access a hardware resource on the mobile device and the JNI bridge is to determine that said native code is resident on the mobile device.

10. The computing device of claim 9 wherein the hardware resource is at least one of a speaker, a display, a microphone, and a button.

11. A method, comprising:
determining, by a computing device and based on a Java Native Interface (JNI) call for native code, whether the native code associated with the JNI call is resident on the computing device or on a mobile device;
if the native code is resident on the computing device, executing the native code by the computing device; and
if the native code is resident on the mobile device, providing the JNI call to a JNI proxy on the computing device and forwarding, by the JNI proxy on the computing device, the JNI call to a JNI proxy on the mobile device, and executing the native code on the mobile device.

12. The method of claim 11 further comprising, if the native code is resident on the mobile device, providing the JNI call from the JNI proxy on the mobile device to a JNI bridge on the mobile device.

13. The method of claim 12 wherein determining whether the native code associated with the JNI call is resident on the computing device or on the mobile device comprises accessing a data structure in a JNI bridge on the computing device, said data structure specifying native code locations.

14. The method of claim 11 wherein, if the native code is resident on the mobile device, the method further comprises executing the native code to access a hardware resource on the mobile device including at least one of a speaker, a display, a microphone, and a button.

15. The method of claim 11 wherein, if the native code is resident on the mobile device, the method further comprises generating a response by the native code and providing the response through the JNI proxy on the mobile device to the JNI proxy on the computing device.
